(19) United States
(12) Patent Application Publication
(10) Pub. No.: US 2005/0004870 A1
(43) Pub. Date: Jan. 6, 2005

(54) Methods and apparatus for sharing revenue associated with negative collection information

(76) Inventor: Richard D. McGaughey, Racine, WI (US)

Correspondence Address: Richard D. McGaughey, 2901 Chatham Street, Racine, WI, 53402, US

(21) Appl. No.: 10/676,769

(22) Filed: Oct. 1, 2003

Related U.S. Application Data
(60) Provisional application No. 60/415,336, filed on Oct. 1, 2002.

(51) Int. Cl. G06F 17/60

(52) U.S. Cl. 705/42; 705/35

(57) ABSTRACT

Methods and apparatus for sharing revenue associated with receiving and distributing negative collection information and for displaying that information in real-time are provided. The disclosed system receives the negative collection information from a plurality of collection agencies via machine readable media and/or a network such as the Internet. The negative collection information is logically associated with one or more submitting collection agencies and merged with previously received negative collection information. When the system receives a request for a credit report from an authorized subscriber, the requested report is provided to the subscriber in real-time for a fee. The fee may be a periodic fee and/or a per use fee. A portion of this fee is then shared with the collection agency or agencies that provided the negative collection information based on the level of contribution of each agency.

This application claims the benefit of U.S. Provisional Application No. 60/415,335, filed Oct. 1, 2002.

### TECHNICAL FIELD

The present invention relates in general to computer systems and, in particular, to methods and apparatus for electronically reporting credit information and for sharing revenue associated with negative collection information. The uploaded information is automatically tallied and reported via a computer that is configured to provide up-to-date, on demand information to a collection information supplier any time.

### BACKGROUND

Often, when a person or company is extended financial credit and that credit is in default, the matter is turned over to a collection agency for resolution. Typically, the collection agency reports this “negative” credit information to a credit bureau once a month on a magnetic tape. However, most collection agencies are under no legal or financial obligation to report the negative collection information to the credit bureau. The credit bureau stores negative collection information collected from hundreds of collection agencies in a database.

For a fee, subscribers to the database may access the negative collection information. typically these subscribers sell this service to potential creditors to facilitate avoidance of bad debt. Often, collection agencies are subscribers to the database. As a result, potential creditors ay a first fee to the collection agency (or other subscriber), and the collection agency in turn pays a fee to the credit bureau.

This system of collecting and distributing negative collection information has certain drawbacks. First, the collection agencies are under no legal or financial obligation to report the negative collection information to the credit bureaus. As a result, the database does not contain as much negative collection information as it could contain. Second, the database is only updated periodically. As a result, negative credit information that may have resulted in avoidance of bad debt may be missed by a creditor. Conversely, some creditors require resolution of all credit issues before extending additional credit. As a result, people and/or companies may be forced to wait several weeks until their credit is cleared in the database.

Another shortcoming is that, while current database technology does provide record keeping and reporting capabilities, the known technology is hampered by limited reporting options. Commercial database software can provide a place where business records are kept and continuously updated by users. Custom reports of the information a user needs at a specific time can be created and run when necessary. However, there is generally no provision for providing updated and electronically available reports in real-time. It would therefore be highly desirable to design an automated reporting tool that can provide accurate, up-to-date information automatically and in real-time.

### SUMMARY OF THE INVENTION

The present invention overcomes the aforementioned drawbacks by providing an apparatus and methods for automatically reporting the current credit information, including negative collection information, of a debtor. It does this by reporting the current credit information in real-time.

In one aspect of the invention, a system receives collection information, preferably negative collection information, from a plurality of collection agencies via machine readable media and/or a network such as the internet. The negative collection information is logically associated with one or more submitting collection agencies and merged with previously received negative collection information. When the system receives a request for a credit report from an authorized subscriber, the requested report is credibly provided in real-time to the subscriber for a fee. The fee may be a periodic fee and/or a per use fee. A portion of this fee can then be shared with the collection agency or agencies that provided the negative collection information based on the level of contribution of each agency. The foregoing and other features of the present invention will be apparent from the detailed description that follows.

### BRIEF DESCRIPTION OF THE DRAWINGS

FIG. 1 is a block diagram of an example network environment.

FIG. 2 is a block diagram of an example client computer system.

FIG. 3 is a block diagram of an example server computer system.

FIG. 4 is a flowchart of an example process for sharing revenue 20 associated with negative collection information.

FIGS. 5A through 5F illustrate an exemplary data entry report format presented to the on-line supplier or subscriber.

FIG. 6 is an application program interface overview block diagram illustrating an embodiment of the invention.

### DETAILED DESCRIPTION

Reference is now made to the drawings in detail wherein like numbers represent like elements throughout. In general, the example methods and apparatus described herein facilitate he sharing of revenue associated with receiving and distributing negative collection information. The disclosed system receives the negative collection information from a plurality of collection agencies via machine readable media and/or a network such as the Internet. The negative collection information is logically associated with one or more submitting collection agencies and merged with previously received negative collection information. When the system receives a request for a credit report from an authorized subscriber, the requested report is provided to the subscriber for a fee. The fee may be a periodic fee and/or a per use fee. A portion of this fee is then shared with the collection agency or agencies that provided the negative collection information based on the level of contribution of each agency.

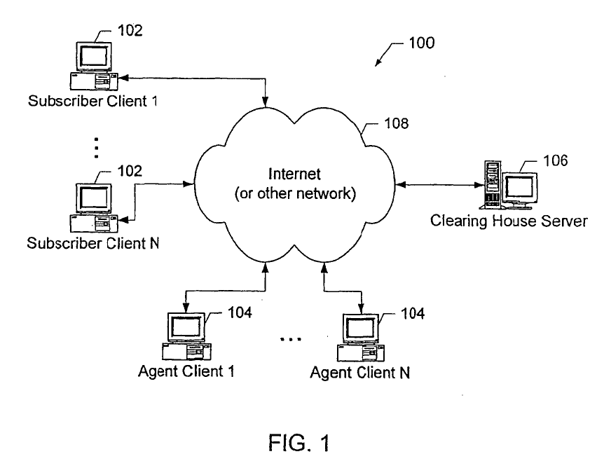

A block diagram of an exemplary network communications system 100 is illustrated in FIG. 1. Typically, the system 100 includes one or more subscriber devices 102, one or more agent devices 104, and one or more clearinghouse servers 106. Each of these devices 102, 104, 106 may communicate with each other via a connection to one or more communications channels 108 such as the Internet or some other electronic network.

Typically, the clearinghouse server 106 stores a plurality of files, programs, and/or web pages for use by the subscriber devices 102 and/or the agent devices 104. One clearinghouse server 106 may interact with a large number of subscriber devices 102 and/or the agent devices 104. Accordingly, each clearinghouse server 106 is typically a high end computer with a large storage capacity, one or more fast microprocessors, and one or more high speed network connections. Conversely, relative to a typical clearinghouse server 106, each subscriber device 102 and each agent device 104 typically includes less storage capacity, a single microprocessor, and a single network connection.

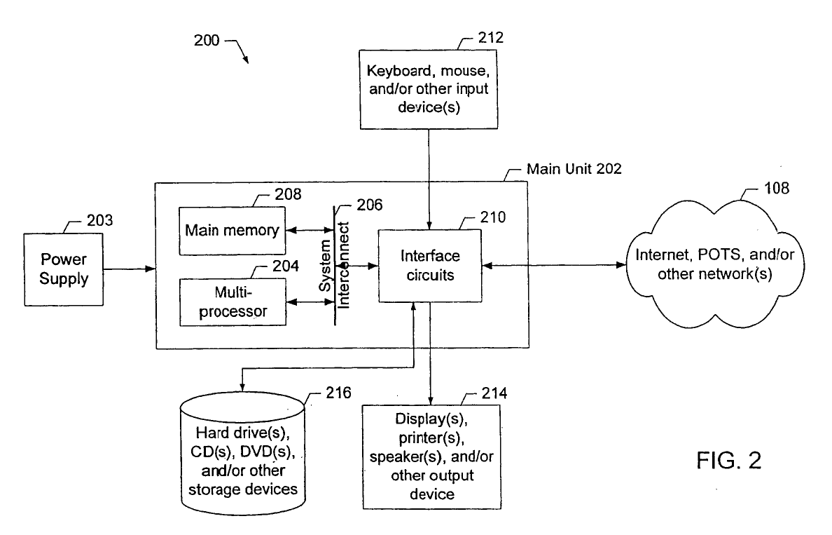

A block diagram of an example computer system 200 is illustrated in FIG. 2. The computer system 200 may serve as a subscriber device 102 and/or an agent device 104. The computer system 200 may be a personal computer (PC), a personal digital assistant (PDA), an Internet appliance, a cellular telephone, or any other computing device. In an example, the computer system 200 includes a main unit 202 powered by a power supply 203. The main unit 202 may include a processor 204 electrically coupled by a system interconnect 206 to a main memory device 208 and one or more interface circuits 210. In an example, the system interconnect 206 is an address/data bus. Of course, a person of ordinary skill in the art will readily appreciate that interconnects other than busses may be used to connect the processor 204 to the main memory device 208. For example, one or more dedicated lines and/or a crossbar may be used to connect the processor 204 to the main memory device 208.

The processor 204 may include any number of processing agents and/or processor resources. For example, the processor 204 may include an integer execution unit, a floating-point unit, a single instruction multiple data (SIMD) unit, etc. The processor 204 may include any type of well known processing unit, such as—a microprocessor from the Intel Pentium™ family of microprocessors, the Intel XScale™ family of microprocessors, and/or the Intel XScaIe™ family of processors. The processor 204 may also include any type of well known cache memory, such as static random access memory (SRAM).

The main memory device 208 may include dynamic random access memory (DRAM) and/or any other form of random access memory. For example, the main memory device 208 may include double data rate random access memory (DDRAM). The main memory device 208 may also include non-volatile memory such as FLASH memory. In an example, the main memory device 208 stores a software program which is executed by the processor 204 in a well known manner.

The interface circuit(s) 210 may be implemented using any type of well known interface standard, such as an Ethernet interface and/or a Universal Serial Bus (USB) interface. One or more input devices 212 may be connected to the interface circuits 210 for entering data and commands into the main unit 202. For example, an input device 212 may be a keyboard, mouse, touch screen, track pad, track ball, isopoint, and/or a voice recognition system.

One or more displays, printers, speakers, and/or other output devices 214 may also be connected to the main unit 202 via one or more of the interface circuits 210. The display 214 may be cathode ray tube (CRTs), liquid crystal displays (LCDs), or any other type of display. The display 214 may generate visual indications of data generated during operation of the main unit 202. The visual displays may include prompts for human operator input, calculated values, detected data, etc.

The computer system 200 may also include one or more storage devices 216. For example, the computer system 200 may include one or more hard drives, a compact disk (CD) drive, a digital versatile disk drive (DVD), and/or other computer media input/output (I/O) devices.

Preferably, the computer system 200 may also exchange data with other devices via a connection to the network 108. The network connection may be any type of network connection, such as an Ethernet connection, digital subscriber line (DSL), telephone line, coaxial cable, etc. The network 108 may be any type of network, such as the Internet, a telephone network, a cable network, and/or a wireless network.

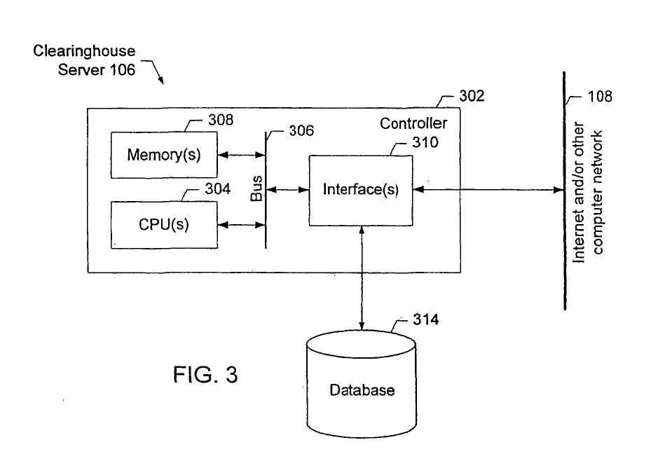

A more detailed block diagram of a clearinghouse server 106 is illustrated in FIG. 3. Like the computer system 200 described above, the controller 302 in the server 106 preferably includes a central processing unit 304 electrically coupled by an address/data bus 306 to a memory device 308 is and a network interface circuit 310. However, the server controller 302 is typically more powerful than the client controller 202. Again, the CPU 304 may be any type of well known CPU, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by other devices. Preferably, the database 314 stores negative collection information collected from hundreds of collection agencies as well as other data.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

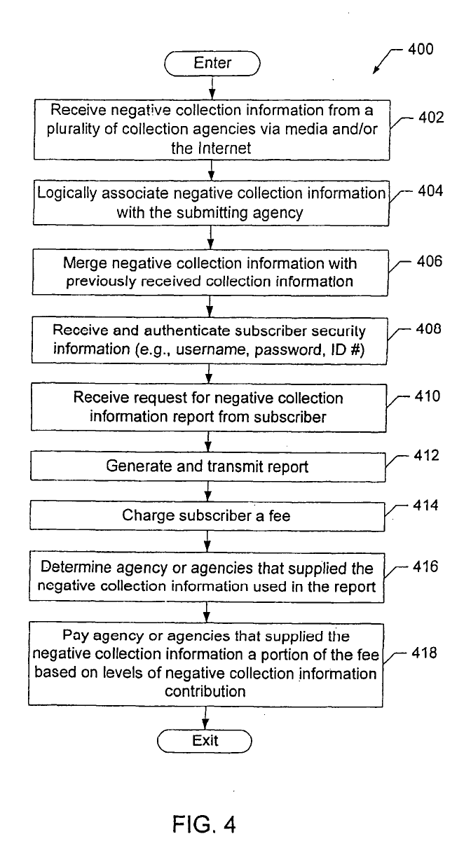

A flowchart of a process 400 for sharing revenue associated with negative collection information is illustrated in FIG. 4. Preferably, the process 400 is embodied in a software program or a set of computer instructions which are stored in memory 208 and executed by the processor 204 in a well known manner. However, some or all of the blocks of the process 400 may be performed manually and/or by another device. Although the process 400 is described with reference to the flowchart illustrated in FIG. 4, a person of ordinary skill in the art will readily appreciate that many other methods of performing the process 400 may be used. For example, the order of many of the blocks may be changed, and/or the blocks themselves may be changed, combined and/or eliminated.

Generally, the process 400 causes the processor 204 to share revenue associated with receiving and distributing negative collection information. The disclosed system receives the negative collection information from a plurality of collection agencies via machine readable media and/or a network such as the Internet. The negative collection information is logically associated with one or more submitting collection agencies and merged with previously received negative collection information. When the system receives a request for a credit report from an authorized subscriber, the requested report is provided to the subscriber for a fee. The fee may be a periodic fee and/or a per use fee. A portion of this fee is then shared with the collection agency or agencies that provided the negative collection information based on the level of contribution of each agency.

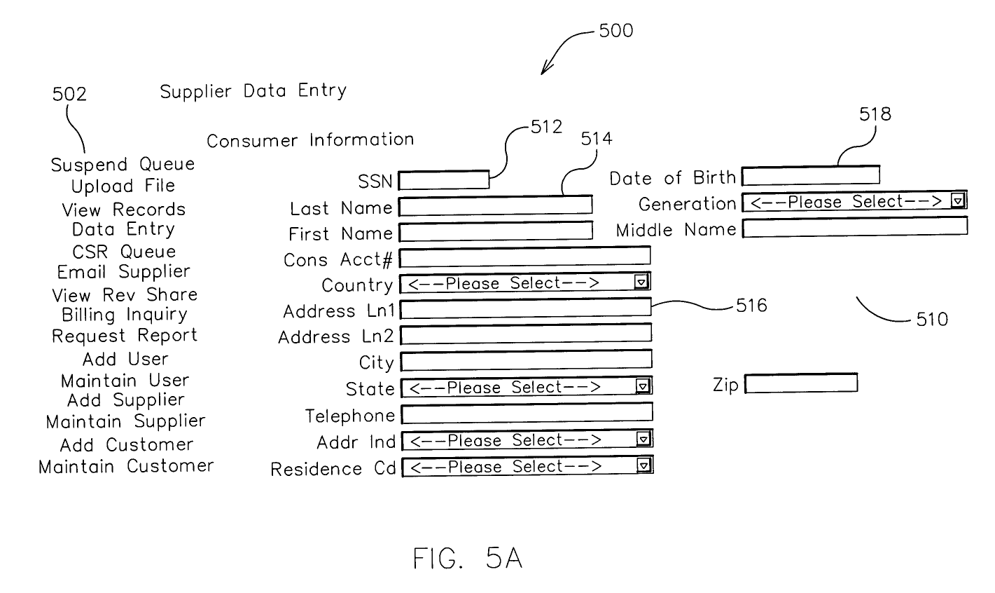

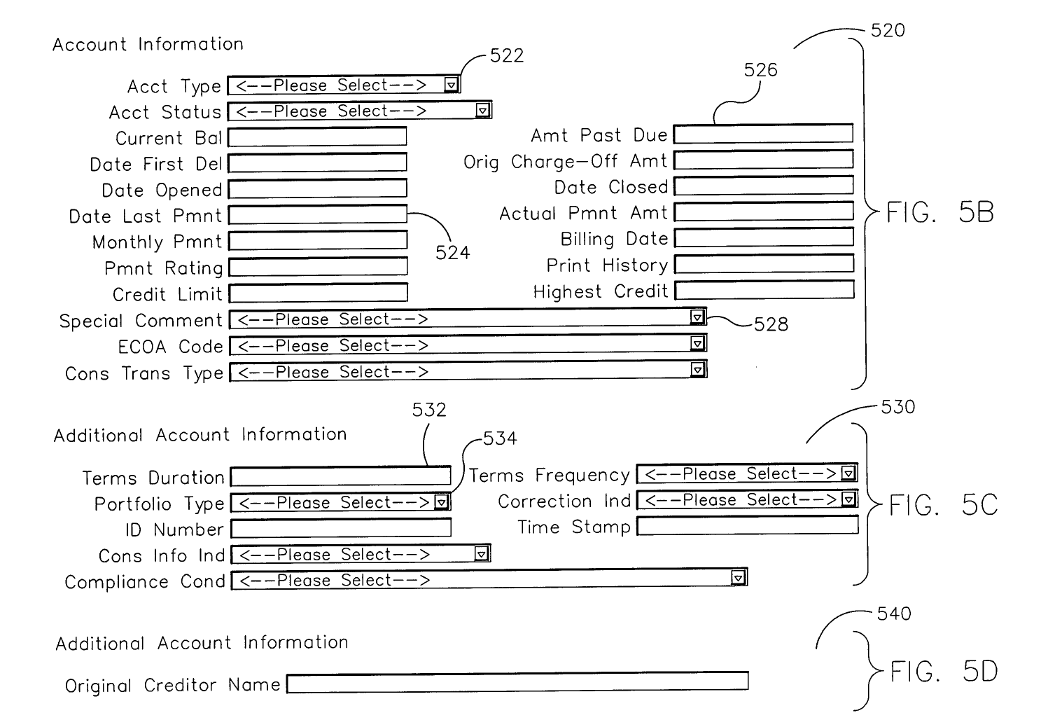

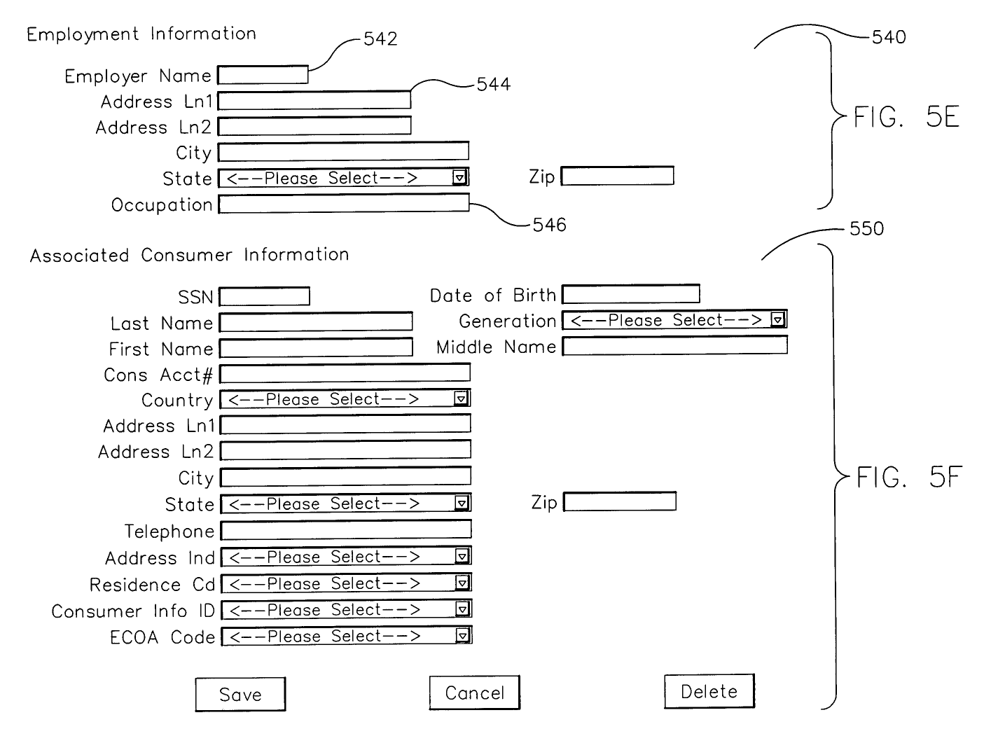

The process 400 begins when the clearinghouse server 106 receives negative collection information from a plurality of collection agencies (block 402). The information may be received from an agent device 104 via the Internet and/or via conventional non-volatile storage devices such as magnetic media and/or optical media. Each portion of negative collection information is logically associated with the collection agency that submitted the information in the database 314 of negative collection information (block 404). See also FIG. 5. The newly received collection information is preferably merged with previously received information (block 406). In other words, redundant information is not stored in the database 314. If more than one collection agency reports the same collection information, a logical association between the collection information and each of the reporting agencies may be stored in the database 314.

Subsequently, the clearinghouse server 106 receives and authenticates login information from a subscriber (block 408). The login information may include a username, a password, an identification number, and/or any other type of identifier. If the login information is authentic, the clearinghouse server 106 may receive a request for a credit report from the subscriber (block 410). In one example, the subscriber requests the credit report via a web browser interface.

The credit report includes some of the negative collection information received from the collection agencies. Specifically, the credit report includes collection information associated with a particular individual or company associated with the report request. Once the credit report is generated, it is transmitted to the subscriber (block 412). In one example, the credit report is transmitted to a web browser. In this fashion, the subscriber is instantaneously provided with a credit report that is generated in real-time. The information contained in the credit report includes negative collection information that is current, up to date, and credible. In order to receive these credit reports, the subscriber is charged a fee (block 414). The fee may be a periodic subscription fee and/or a transaction fee (e.g., a per report fee).

The clearinghouse server 106 then determines the agency or agencies that supplied the negative collection information used to generate the report (block 416), and a portion of the subscriber's fee is paid to those agencies (block 418). Preferably, each contributing agency is paid in proportion to that agency's level of contribution. The level of contribution may be a function of the amount and/or type of negative collection information received from a collection agency that is incorporated in a credit report. Similarly, the level of contribution may be a function of the amount and/or type of negative collection information received from a collection agency over a predetermined period of time.

FIGS. 5A through 5F illustrate one format of data entry screen 500 that may be used with the present invention by a supplier or subscriber for uploading collection information. As shown, the data entry screen 500 includes a navigation bar 502 for readily accessing different portions of the program and performing different functions with it. The screen display 500 includes a first portion 510 for identifying the consumer or debtor. For example, entry boxes are provided to identify the consumer's Social Security Number 512, his or her name 514, address 516 and birth date 518. See FIG. 5A. Another portion, the account information portion 520 shown in FIG. 5B calls for information that is particular to the supplier or submitting agency. As shown, it includes entry boxes for the type 522 and status of a given account. Entry boxes are also provided for information as to the last payment date 524, the past due amount 526, and any special comments 528 that the subscriber may have. Continuing to scroll down the screen display, additional account information 530, 540 fields are shown in FIGS. SC and 5D, respectively. In them, additional information such as the duration of any terms 532 and portfolio type 534 may be entered. An employment information field 540 is shown in FIG. 5E wherein the subscriber can enter employer 542, 544 and occupation 546 information. Finally, an associated consumer information field 550 is illustrated in FIG. 5F. It will be obvious that the information submitted is variable according to the requirements and desires of each supplier or subscriber. For example, it may be significant to report the a given debtor has filed for bankruptcy protection or that he or she has related companies. Accordingly, any relevant debtor information and negative collection information may be submitted in this fashion without deviating from the scope of the present invention.

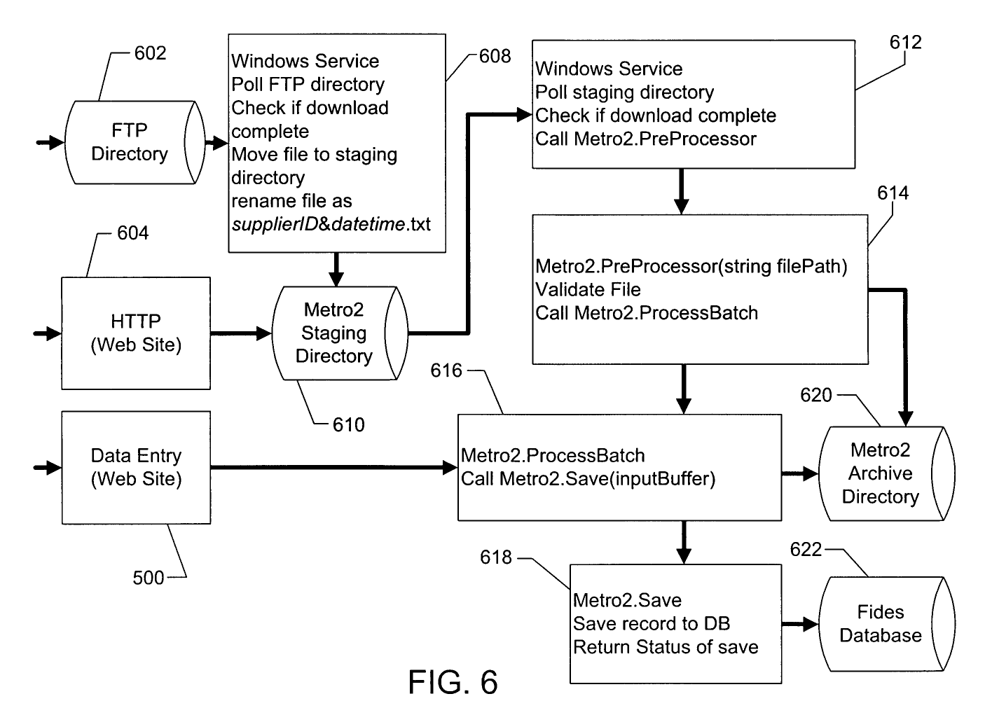

Referring now to FIG. 6, it illustrates a data application program interface (API) overview of the present invention. The API is the interface by which the application program accesses the operating system and is defined at source code level, providing a level of abstraction between the application and other privileged utilities to ensure the portability of the code. Specifically, it is designed as a separate program that collects and works with data in a database. The program provides real-time reporting capabilities that are not available to users of other currently-available systems. Other embodiments of the invention may use different hardware and/or software manifestations to embody the invention in accordance with their particular design.

As shown in FIG. 6, negative collection information may be obtained by means of suppliers dropping files on the system's file transfer protocol (FTP) directory 602 or by upload through the system's web site 604. A dropped file results in the FTP directory being polled to check the status of the input line or memory location to see if the external event has been registered. Once the download is complete, the file is moved to a staging directory and renamed as supplierID&datetime.txt. A file uploaded directly via the website 604 is saved as supplierID&datetime.txt. Both are held within a Metro2 staging directory 610. The Metro2 staging directory 610 is then polled 612. If the download is complete, the Metro2.PreProcessor 612 is called.

Under Metro2.PreProcessor (string filepath) 614, this method will look at a Metro2 file to determine if it has the proper header and trailer. The processing summary is as follows:
Put an entry in the SupplierSummary table for this file
Open the file
Check if the first record is a Header record (position 5-10 contain HEADER)
Check if last record is a Trailer record (position 5-11 contain TRAILER)
Close the file
If either Header or Trailer are missing
   Flag SupplierSummary row as batch rejected
   Move file from staging to archive directory
   Send Disposition e-mail to supplier indicating the entire batch was rejected
If Header and Trailer are present
   Call Metro2.ProcessorBatch(string filePath, int supplierID, int supplierBatchSummaryID)

Under Metro2.ProcessBatch 616, or Metro2.ProcessBatch(string filePath, int supplierID, int upplierBatchSummaryID), this method will process files received via upload and FTP. The prerequisite is that the system must determine which totals on the Trailer record will be balances against. The processing summary is as follows:
Open the file
Read first Metro2 record
Call Metro2.Save(inputBuffer)
Record statistic on the record (valid, invalid, etc.)
Process file until end of file (EOF)
When EOF
   Compare Trailer record totals to the statistics kept during the process
   Update SupplierBatchSummary table
   Send disposition e-mail
Close the file
Move the file to archive directory

At this point, the files are archived 620 or saved 618 in the system's database 622 for supplier access as is desired or required. Negative collection information saved in this fashion is accessible in real-time by the suppliers who subscribe to the system and who supply information for inclusion in the archives 620 or database 622.

In summary, persons of ordinary skill in the art will readily appreciate that methods and apparatus for providing negative collection information in real-time to suppliers and for sharing revenue associated with that negative collection information have been provided. The foregoing description has been presented for the purposes of illustration and description. It is not intended to be exhaustive or to limit the scope of this patent to the examples disclosed. Many modifications and variations are possible in light of the above teachings. It is intended that the scope of this patent be defined by the claims appended hereto as reasonably interpreted literally and under the doctrine of equivalents.

1. A method of sharing revenue associated with receiving and distributing negative collection information, the method comprising:
receiving first negative collection information from a first collection agency;
storing data indicative of the first collection agency and the first negative collection information with a logical association between the data indicative of the first collection agency and the first negative collection information;
receiving second negative collection information from a second collection agency;
storing data indicative of the second collection agency and the second negative collection information with a logical association between the data indicative of the second collection agency and the second negative collection information;
receiving login information from a subscriber;
authenticating the login information;
receiving a request for a credit report from the subscriber;
generating the credit report, the credit report incorporating at least a portion of the first negative collection information;
transmitting the credit report to the subscriber; charging the subscriber a first fee; and
paying the first agency a second fee.

2. A method as defined in claim 1, wherein paying the first agency a second fee comprises determining the credit report incorporates at least a portion of the first negative collection information.

3. A method as defined in claim 2, wherein determining the credit report incorporates at least a portion of the first negative collection information comprises retrieving the logical association between the data indicative of the first collection agency and the first negative collection information.

4. A method as defined in claim 1, wherein generating the credit report includes generating the credit report to incorporate at least a portion of the second negative collection information.

5. A method as defined in claim 4, further comprising paying the second agency a third fee.

6. A method as defined in claim 5, wherein the second fee is based on a level of negative collection information contribution from the first collection agency and the third fee is based on a level of negative collection information contribution from the second collection agency.

7. A method as defined in claim 6, wherein the level of negative collection information contribution from the first collection agency is a function of the amount of negative collection information received from the first collection agency that is used in the credit report.

8. A method as defined in claim 6, wherein the level of negative collection information contribution from the first collection agency is a function of the type of negative collection information received from the first collection agency that is used in the credit report.

9. A method as defined in claim 6, wherein the level of negative collection information contribution from the first collection agency is a function of the amount of negative collection information received from the first collection agency over a predetermined period of time.

10. A method as defined in claim 5, wherein a ratio of the second fee over the third fee is within 10% of a ratio of an amount of first negative collection information over an amount of second negative collection information.

11. A method as defined in claim 5, wherein the sum of the second fee added to the third fee is less than the first fee.

12. A method as defined in claim 1, wherein the second fee comprises a portion of the first fee.

13. A method as defined in claim 1, wherein the first fee is a periodic subscription fee.

14. A method as defined in claim 1, wherein the first fee is a transaction fee associated with generating the credit report.

15. A method as defined in claim 1, wherein the first negative collection information is associated with a person and the method further comprises merging the first negative collection information with previously stored negative collection information associated with the person.

16. A method as defined in claim 1, wherein receiving first negative collection information from a first collection agency comprises receiving the first negative collection information via the Internet.

17. A method as defined in claim 16, wherein receiving first negative collection information from a first collection agency does not include receiving the first negative collection information via any of a magnetic tape, a magnetic disk, and an optical disk.

18. A method as defined in claim 16, wherein receiving first negative collection information from a first collection includes receiving the first negative collection information via any of a magnetic tape, a magnetic disk, and an optical disk.

19. An apparatus structured to share revenue associated with negative collection information, the apparatus comprising:
a processor; and
a memory device operatively coupled to the processor, the memory device storing a software program structured to cause the processor to:
receive first negative collection information from a first collection agency;
store data indicative of the first collection agency and the first negative collection information with a logical association between the data indicative of the first collection agency and the first negative collection information;
receive second negative collection information from a second collection agency;
store data indicative of the second collection agency and the second negative collection information with a logical association between the data indicative of the second collection agency and the second negative collection information;
generate a credit report, the credit report incorporating at least a portion of the first negative collection information;
charge a subscriber a first fee; and
pay the first agency a second fee based on a level of contribution of negative collection information from the first collection agency.

20. An apparatus as defined in claim 19, wherein the software program is further structured to cause the processor to:
receive login information from the subscriber;
authenticate the login information;
receive a request for the credit report from the subscriber; and
transmit the credit report to the subscriber.

21. An apparatus as defined in claim 19, wherein the level of contribution from the first collection agency is a function of the amount of negative collection information received from the first collection agency that is used in the credit report.

22. An apparatus as defined in claim 19, wherein software program is structured to receive the first negative collection information via the Internet.

23. A machine readable medium storing instructions structured to cause a machine to:
receive first negative collection information from a first collection agency;
store data indicative of the first collection agency and the first negative collection information with a logical association between the data indicative of the first collection agency and the first negative collection information;
receive second negative collection information from a second collection agency;
store data indicative of the second collection agency and the second negative collection information with a logical association between the data indicative of the second collection agency and the second negative collection information;
generate a credit report, the credit report incorporating at least a portion of the first negative collection information;
charge a subscriber a first fee; and
pay the first agency a second fee based on a level of contribution of negative collection information from the first collection agency.

24. A machine readable medium as defined in claim 23, wherein the instructions are further structured to cause the machine to:
receive login information from the subscriber;
authenticate the login information;
receive a request for the credit report from the subscriber; and
transmit the credit report to the subscriber.

25. A machine readable medium as defined in claim 24, wherein the level of contribution from the first collection agency is a function of the amount of negative collection information received from the first collection agency that is used in the credit report.

26. A machine readable medium as defined in claim 25, wherein instructions are further structured to cause the machine to receive the first negative collection information via the internet.

27. A method for displaying collection information in real-time, said collection information being received from one or more subscribers, the method comprising:
receiving first collection information from a first collection agency;
storing data indicative of the first collection agency and the first collection information with a logical association between the data indicative of the first collection agency and the first collection information;
receiving second collection information from a second collection agency;
storing data indicative of the second collection agency and the second collection information with a logical association between the data indicative of the second collection agency and the second collection information;
receiving login information from a subscriber;
authenticating the login information;
receiving a request for a credit report from the subscriber;
generating the credit report in real-time, the credit report incorporating at least a portion of the first collection information; and
transmitting the credit report to the subscriber.

28. A method as defined in claim 27, wherein the first and second collection information includes negative collection information.

29. A method as defined in claim 28, wherein generating the credit report which incorporates at least a portion of the first negative collection information comprises retrieving the logical association between the data indicative of the first collection agency and the first negative collection information.

30. A method as defined in claim 27, wherein generating the credit report includes generating the credit report to incorporate at least a portion of the second collection information.

31. A method as defined in claim 28, wherein the first negative collection information is associated with a person and the method further comprises merging the first negative collection information with previously stored negative collection information associated with the person.

32. A method as defined in claim 28, wherein receiving first negative collection information from a first collection agency comprises receiving the first negative collection information via the Internet.

33. A method as defined in claim 32, wherein receiving first negative collection information from a first collection agency does not include receiving the first negative collection information via any of a magnetic tape, a magnetic disk, and an optical disk.

34. A method as defined in claim 32, wherein receiving first negative collection information from a first collection includes receiving the first negative collection information via any of a magnetic tape, a magnetic disk, and an optical disk.

35. An apparatus structured to display collection information to one or more subscribers in real-time, said one or more subscribers being suppliers of the collection information, the apparatus comprising:
a processor; and
a memory device operatively coupled to the processor, the memory device storing a software program structured to cause the processor to:
receive first collection information from a first collection agency;
store data indicative of the first collection agency and the first collection information with a logical association between the data indicative of the first collection agency and the first collection information;
receive second collection information from a second collection agency;
store data indicative of the second collection agency and the second collection information with a logical association between the data indicative of the second collection agency and the second collection information; and
generate a credit report, the credit report incorporating at least a portion of the first collection information.

36. An apparatus as defined in claim 35, wherein the software program is further structured to cause the processor to:
receive login information from the subscriber;
authenticate the login information;
receive a request for the credit report from the subscriber; and
transmit the credit report to the subscriber in real-time.

37. An apparatus as defined in claim 36, wherein the first and second collection information is negative collection information received from the first and second collection agencies that is used in the credit report.

38. An apparatus as defined in claim 37, wherein software program is structured to receive the first and second negative collection information via the Internet.

39. A machine readable medium storing instructions structured to cause a machine to:
receive first collection information from a first collection agency;
store data indicative of the first collection agency and the first collection information with a logical association between the data indicative of the first collection agency and the first collection information;
receive second collection information from a second collection agency;
store data indicative of the second collection agency and the second collection information with a logical association between the data indicative of the second collection agency and the second collection information; and
generate a credit report, the credit report incorporating at least a portion of the first collection information.

40. A machine readable medium as defined in claim 39, wherein the instructions are further structured to cause the machine to:
receive login information from the subscriber;
authenticate the login information;
receive a request for the credit report from the subscriber; and
transmit the credit report to the subscriber.

41. A machine readable medium as defined in claim 40, wherein the first and second collection information includes negative collection information.

42. A machine readable medium as defined in claim 41, wherein instructions are further structured to cause the machine to receive the first negative collection information via the internet.
